(19) United States
(12) Patent Application Publication
(10) Pub. No.: US 2017/0103359 A1
(43) Pub. Date: Apr. 13, 2017

(54) IDENTIFYING AND ASSIGNING MICROTASKS

(71) Applicant: Microsoft Technology Licensing, LLC, Redmond, WA (US)

(72) Inventors: Jaime Teevan, Bellevue, WA (US); Shamsi Tamara Iqbal, Redmond, WA (US); Curtis von Veh, Redmond, WA (US); Daniel Liebling, Seattle, WA (US); Semiha Ece Kamar Eden, Redmond, WA (US); Andres Monroy-Hernandez, Seattle, WA (US); Pallavi Choudhury, Redmond, WA (US); Kristina Toutanova, Redmond, WA (US); Saleema Amershi, Seattle, WA (US)

(21) Appl. No.: 14/880,305

(22) Filed: Oct. 12, 2015

(51) Int. Cl. G06Q 10/06; G06Q 10/10

(52) U.S. Cl. CPC G06Q 10/063114; G06Q 10/1097

(57) ABSTRACT

Edits on a content item, such as a document, are divided into microtasks. The microtasks associated with a document can be automatically identified based on a workflow or can be identified by a user such as the creator of the content item or an administrator. The microtasks can be assigned to one or more workers including the creator of the content item. When a determination is made that an assigned worker is available to complete a microtask (e.g., when the worker is waiting in line, has just closed an application or file, or has just completed a phone call, etc.), the assigned microtask is presented to the worker for completion.

### BACKGROUND

Complex tasks, such as writing an article or organizing a photo library, can be thought of as a set of multiple microtasks. A microtask is a task that can be easily completed in a short time frame with minimal background information or instruction. For example, a task such as writing a blog post may be thought of as a series of microtasks associated with creating each sentence or paragraph based on one or more topics or ideas, and additional microtasks associated with editing and/or proofing each created sentence or paragraph. The task of organizing the photo library may be similarly thought of as microtasks consisting of assigning tags to each photo of the photo library.

Rather than attempt to a complete an entire task at once, a user may attempt to complete the task by completing the microtasks associated with the task over some period of time, or even by assigning those tasks to other users or collaborators. However, there is currently no way to easily determine the microtasks that make up the task, determine when and on what device the user (or other users) can perform the microtasks, and determine which users are best suited to perform each microtask.

### SUMMARY

Edits on a content item, such as a document, are divided into microtasks. The microtasks associated with a document can be automatically identified based on a workflow or can be identified by a user such as the creator of the content item or an administrator. The microtasks can be assigned to one or more workers including the creator of the content item. When a determination is made that an assigned worker is available to complete a microtask (e.g., when the worker is waiting in line, has just closed an application or file, or has just completed a phone call, etc.), the assigned microtask is presented to the worker for completion. By breaking up or separating the larger task of content item creation into smaller microtasks, the content item can be completed, e.g. using spare time that may otherwise have been wasted by the workers assigned to complete the microtasks.

In an implementation, a microtask of a plurality of microtasks is selected by a computing device. Each microtask is associated with metadata comprising an entity and a type. Identifiers of a plurality of workers are received by the computing device. Each worker is associated with metadata comprising an expertise and availability information. A worker of the plurality of workers is selected using a selection model, the metadata associated with each microtask, and the metadata associated with each worker by the computing device. The selected microtask is assigned to the selected worker by the computing device. A result of the selected microtask is received from the selected worker by the computing device.

In an implementation, a document comprising a plurality of text portions is received by a computing device. The document is associated with an entity. A workflow is identified for the document by the computing device. At least one microtask associated with at least one text portion of the plurality of text portions corresponding to the identified workflow is identified by the computing device. The at least one microtask is associated with metadata. A workflow for the identified at least one microtask is identified based on the type associated with the at least one microtask by the computing device. The at least one microtask is provided for completion based on the identified workflow by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for identifying, assigning, and completing microtasks;

FIG. 2 is an illustration of an implementation of an exemplary microtask engine;

FIG. 3 is an illustration of an example user interface for identifying and/or creating microtasks;

FIG. 4 is an illustration of an example user interface before one or more microtasks have been completed;

FIG. 5 is an illustration of another example user interface after one or more microtasks have been completed

FIG. 6 is an illustration of another example user interface showing an assigned microtask that has not been completed;

FIG. 7 is an illustration of another example user interface showing an assigned microtask that has been completed;

FIG. 8 is an illustration of an example user interface showing one or more completed microtasks to a creator or owner of the microtasks;

FIG. 9 is an operational flow of an implementation of a method for selecting a microtask and for receiving results of the selected microtask;

FIG. 10 is an operational flow of an implementation of a method for identifying at least one microtask in a document and for receiving results of the at least one microtask;

FIG. 11 is an operational flow of an implementation of a method for determining that a current state associated with a worker matches a working state and in response to the determination, presenting a microtask to the worker; and

FIG. 12 shows an exemplary computing environment in which example embodiments and aspects may be implemented.

### DETAILED DESCRIPTION

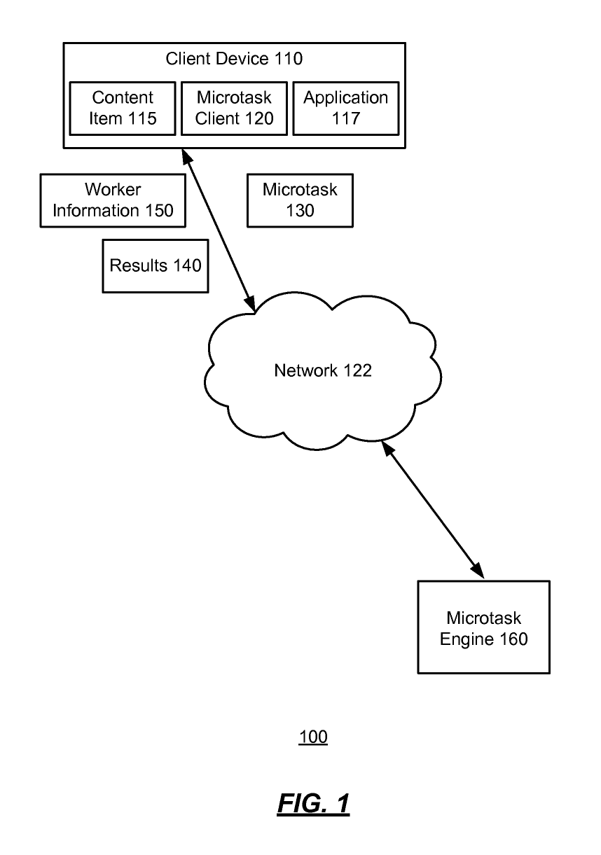

FIG. 1 is an illustration of an exemplary environment 100 for identifying, assigning, and completing microtasks. The environment 100 may include a microtask engine 160 and a client device 110 in communication through a network 122. The network 122 may be a variety of network types including the public switched telephone network (PSTN), a cellular telephone network, and a packet switched network (e.g., the Internet). Although only one client device 110 and one microtask engine 160 are shown in FIG. 1, there is no limit to the number of client devices 110 and microtask engines 160 that may be supported.

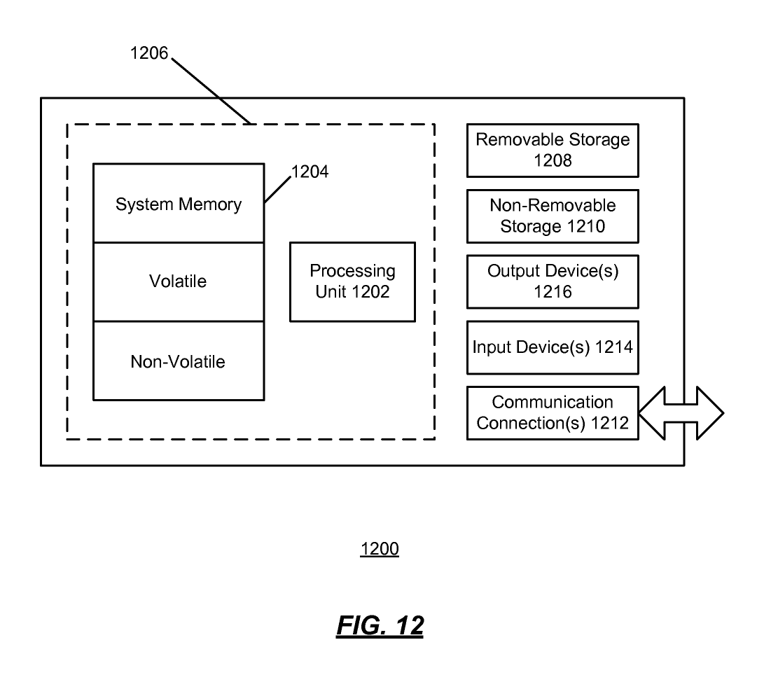

The client device 110 and the microtask engine 160 may be implemented using a variety of a variety of computing devices such as smart phones, desktop computers, laptop computers, tablets, and video game consoles. Other types of computing devices may be supported. A suitable computing device is illustrated in FIG. 12 as the computing device 1200.

An entity associated with the client device 110 may use the client device 110 to create, view, or edit one or more content items 115. The content items 115 may include files, documents, images, videos, music, applications or any other type of content that may be created, viewed, or edited using a computing device. Entities may include individuals (i.e., users), teams, collaborative groups, organizations, corporations, etc.

Entities may create, view, and edit content items 115 using one or more applications 117. Examples of applications 117 may include word processing applications, web browsers, email applications, image and video editing applications, database applications, etc. Any type of application 117 that may create, view, and edit a content item 115 may be supported.

The client device 110 may further include a microtask client 120. The microtask client 120 may allow the user to identify and create one or more microtasks 130 from or based on tasks associated with content items 115. A microtask 130 as used herein is a task (e.g., a short task) that is involved in the creating, completion, or editing of a content item 115. A microtask 130 may not be atomic and be further broken down into smaller microtasks 130.

Typically, a microtask 130 can be completed by an entity in a time that is less than one to five minutes, although more or less time may be specified. In addition, a typical microtask 130 may be completed by an entity without excessive context or other knowledge about the content item 115 associated with a microtask 130. Depending on the implementation, if additional knowledge or context may be needed by the entity to complete the microtask 130, the knowledge or context may be provided by the creator or owner of the microtask 130 to the entity.

For example, a microtask 130 associated with a task such as editing a content item 115 that is a document may be to edit a single paragraph of the document. An entity may edit the paragraph without having to know additional information about the overall document. In some cases, information such as tone (i.e., formal or informal) may be provided to assist the entity in editing the document. Other types of information may be provided.

Depending on the implementation, an entity may use the microtask client 120 to create one or more microtasks 130 for, or from, a task associated with a content item 115. In some implementations, potential microtasks 130 may be identified in the content item 115 automatically by the microtask client 120. For example, with respect to a task such as editing a content item 115, the microtask client 120 may identify one or more paragraphs of a document that include grammatical errors or that are too long. The microtask client 120 may prompt the entity creating the document to create a microtask 130 directed to editing or shortening the identified paragraphs. The identified paragraphs may be displayed using a particular font, highlighting, or underlining that indicates to the entity that a microtask 130 is available.

In other implementations, the entity may identify and/or select the particular microtasks 130 for a content item 115. For example, an entity may highlight a sentence or paragraph in the content item 115. The entity may provide an indication that the entity desires to create a microtask 130 based on the highlighted text.

Each microtask 130 may be associated with metadata. In some implementations, the metadata may include a type, an identifier of the content item 115 associated with the microtask 130, and an identifier of the entity or entities that own or created the microtask 130. The type of microtask 130 may be a description of the work that is associated with the microtask 130. For example, where the content item 115 is a document, the type may be one or more of edit content, shorten content, or generate content. Where the content item 115 is an image, the type may be one or more of crop image, brighten image, filter image, or tag image. Other types of microtasks 130 may be supported.

In addition, the metadata 130 may further include additional data that may be used to complete the microtask 130. The additional data may include instructions or context that may help the worker or entity complete the microtask 130. For example, where the microtask 130 is to generate content, the additional data may include one or more tags or labels that describe ideas that are to be included or covered by the generated content.

The metadata associated with a microtask 130 may further include or identify what is referred to herein as a workflow. A workflow may describe the sequence of steps or processes that are used to complete the associated microtask 130. Depending on the implementation, the workflows may be specified by the microtask client 120 and/or the entities associated with the content items 115.

As may be appreciated, by breaking up a task such as the creation or completion of a content item 115 into a plurality of microtasks 130, the speed at which the content item 115 can be created and/or completed by an entity may be increased. Another advantage of microtasks 130 is referred to herein as “crowdsourcing.” Crowdsourcing allows for the delegation of microtasks 130 to other entities for completion. An entity that has been assigned or delegated a microtask 130 is referend to herein as a worker. As will be described further below, the microtask client 120 may allow the entity to assign a microtask 130 to one or more workers. Once a worker completes the microtask 130, any results 140 may be presented to the entity for approval and, if approved, incorporated into the content item 115.

Another advantage of microtasks 130 is referred to herein as “selfsourcing.” Selfsourcing refers to the process of assigning and/or presenting a microtask 130 to the entity that created the microtasks 130 for completing when it is determined by the microtask client 120 that the entity is available to perform the microtask 130. In some implementations, the microtask client 120 may present a microtask 130 for completion to an entity when the entity logs into their client device 110, when the entity switches tasks, when it is determined that the entity is not being productive (e.g., browsing the Internet), or when it is determined that the entity is waiting in line (e.g., using accelerometers, location sensors, or other sensors associated with the client device 110), for example. As may be appreciated, selfsourcing may allow an entity to capture time that may have been otherwise been lost, and to use the captured time to work towards the completion of the content item 115.

To help facilitate both crowdsourcing and selfsourcing, the environment 100 may further include the microtask engine 160. The microtask engine 160 may receive one or more microtasks 130 from microtask clients 120 of one or more client devices 110, and may assign the microtasks 130 to one or more workers based on metadata associated with the microtask 130. The metadata may be provided the microtask client 120 and may specify the desired characteristics or qualities for a worker to perform the microtask 130. For example, the metadata may specify a desired level of education, language skills, and any other skill or talent that may be useful for completing the microtask 130. In addition, the metadata may specify whether or not there is a budget or monetary compensation associated with the microtask 130. The metadata may be selected by the entity associated with the content item 115, or may be defined by the workflow associated with the microtask 130.

The workers may register to perform microtasks 130 with the microtask engine 160. In some implementations, a worker may register with the microtask engine 160 by providing worker information 150. The worker information 150 may describe the expertise or skills possessed by the worker, indicators of the types of microtasks 130 that the worker may complete, and any compensation that may be requested by the worker. In addition, the worker information 150 may specify a schedule, or other information that may be used to determine that a worker is available to complete a microtask 130. Depending on the implementation, the workers may provide the worker information 150 using microtask clients 120 associated with their client devices 110. Alternatively or additionally, the workers may provide their information using a webpage provided by the microtask engine 160.

After a worker completes an assigned microtask 130, the microtask engine 160 may receive results 140 from the worker. The contents of the results 140 may depend on the type of microtask 130. For example, where the microtask 130 was editing a paragraph, the results 140 may include the edited paragraph by the worker. The microtask engine 160 may provide the generated results 140 to the microtask client 120 associated with the content item 115 where the results 140 may be incorporated into the content item 115 and/or submitted to the entity for approval.

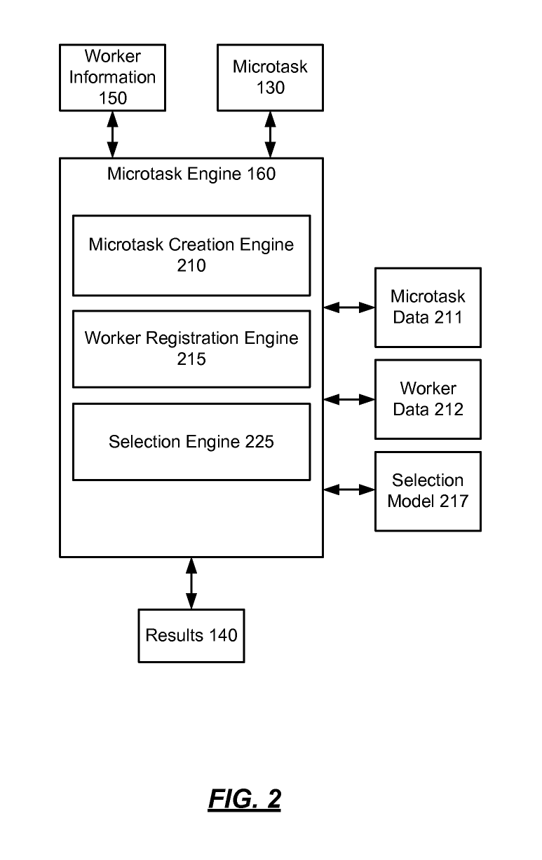

FIG. 2 is an illustration of an implementation of an exemplary microtask engine 160. The microtask engine 160 may include one or more components including a microtask creation engine 210, a worker registration engine 215, and a selection engine 225. More or fewer components may be included in the microtask engine 160. Some or all of the components of the microtask engine 160 may be implemented by one or more computing devices such as the computing device 1200 described with respect to FIG. 12. In addition, some or all of the components of the microtask engine 160 may be implemented as part of the microtask client 120.

The microtask creation engine 210 may allow for the creation and/or identification of microtasks 130 with respect to a content item 115. In some implementations, the microtask creation engine 210 may automatically identify potential microtasks 130 with respect to a content item 110 by identifying aspects or portions of the content item 115 that are unfinished. The microtask creation engine 210 may identify microtasks 130 in the content item 115 by matching patterns associated with microtasks 130 against the text or contents of the content item 115.

In some implementations, the microtask creation engine 210 may identify microtasks 130 using one or more workflows. The workflow may be selected or identified by a user or an administrator based on the type of content item 115 that they are working on. For example, where a content item 115 is a document, the creator of the document may select a workflow related to editing the document. The microtask creation engine 210 may identify microtasks 130 within the document that are associated with the workflow of editing the document such as shortening paragraphs, editing paragraphs, correcting grammatical errors, etc. In another example, where the content item 115 is an image database, the user may select a workflow related to tagging photos or a workflow related to enhancing photos. Depending on which workflow is selected, the microtask creation engine 210 may identity images that are not tagged or enhanced as possible microtasks 130.

In other implementations, the entity associated with the content item 115 may identify potential microtasks 130 in the content item 115. Alternatively or additionally, the microtasks 130 may be identified by other users or entities (i.e., crowdsourced).

The microtask creation engine 210 may display indicators to the entity of the identified one or more microtasks 130. Where the content item 115 is a document, the portions of the document that are identified as possible microtasks 130 may be underlined or displayed using a different color or font to indicate to the entity that microtasks 130 are available. Other types of indications may be used. Alternatively or additionally, a window or other type of user interface element may be displayed that indicates to the entity the microtasks 130 that have been identified in the content item 115.

The microtask creation engine 210 may receive a request to create a microtask 130 from an entity. The request may correspond to one of the potential microtasks 130 identified by the microtask creation engine 210 using the workflow. Alternatively, the request may correspond to a microtask 130 identified by the entity or by other entities using crowdsourcing, for example.

The requested microtask 130 may include metadata that identifies various characteristics of the requested microtask 130 such as the type of microtask, the associated entity or entities, and the associated content item 115. The metadata may further include data related to the workers that may complete the microtask 130 such as whether or not the microtask 130 can be completed by workers (i.e., crowdsource) or can be completed by the entity itself (i.e., selfsource), the number of workers that may complete the microtask 130, and what qualities or characteristics are desired in the worker(s) that may complete the microtask 130 (e.g., education level, number of or quality of reviews or feedback given to worker, expertise, and skills). The metadata may also include a desired completion date and may indicate any compensation that is associated with the microtask 130.

In some implementations, some or all of metadata associated with the microtask 130 may be provided by the entity associated with the microtask 130. For example, the microtask client 120 may generate a user interface element through which the entity may specify whether the microtask 130 is to be selfsourced or crowdsourced, may enter the compensation associated with the microtask 130, and may enter the skills and expertise that are desired for the worker(s) that may complete the microtask 130.

Depending on the implementation, the metadata associated with the microtask 130 may also be defined by a workflow associated with the microtask 130. As described above, some microtasks 130 may have an associated workflow that includes the steps or processes that may be performed to complete the microtask 130. Examples of metadata that may be defined by the workflow may be the skill or experience of the workers that may complete the microtask 130 and the compensation associated with the microtask 130. Other types of metadata may be defined by the workflow associated with the microtask 130. Depending on the implementation, the microtask creation engine 210 may receive the workflow associated with the microtask 130 from the microtask client 120, or may retrieve the stored workflow for the microtask 130 from microtask data 211.

The microtask creation engine 210 may store microtasks 130 that are created along with the associated metadata in the microtask data 211. Depending on the implementation, the stored microtasks 130 may include the date that they were created and a date that they may be completed by. Depending on the implementation, each stored microtask 130 may further include priority information that may be used when selecting microtasks for completion. The priority information may be based on the entity associated with each microtask 130, for example.

The worker registration engine 215 may allow for the creation and management of a pool of available workers to fulfill microtasks 130. Workers may sign up or register with the worker registration engine 215 to complete microtasks 130 by providing worker information 150 such as skills, expertise, types of microtasks desired, availability information (i.e., when the worker can perform microtasks 130), requested compensation (if any), and identifiers of the client device 110 where they may be provided microtasks 130.

The worker information 150 may be used to determine when the workers are in what is referred to herein as a “working state.” A working state may be the state where a worker is available and willing to perform microtasks 130. As described above, workers may include the creator or the author of each microtask 130 (i.e., for selfsourcing). Depending on the implementations, the workers may be asked to select or identify times or events during which they would like to receive microtasks in the worker information 150. For example, a worker may indicate that they would like to receive microtasks when they are waiting in line, after they have closed or a waiting on a particular application 117, after they have logged in to a particular client device 110, when they are commuting (e.g., on a train), or when they are wasting time. In addition, the workers may also specify rules for determining a working state that are based the time of day or which client device 110 they are using (e.g., “never receive microtasks 130 when using a work computer,” and “receive microtasks 130 when using a laptop on the weekend”).

Workers may also provide indicators of when they are currently available. For example, when a worker would like to receive a microtask 130 they may send a message to the worker registration engine 215 that they are available to perform a microtask 130. The worker may provide the indication using a smart phone application, or by logging into a website associated with microtasks 130.

Depending on the implementation, the information used to determine when the worker is in a working state may be augmented by the worker registration engine 215 based on the observed behavior of the particular worker or entity. For example, if a worker tends to not accept microtasks 130 assigned after 5 pm, then the worker registration engine 215 may determine that the worker is not in a working state after 5 pm and may update the worker information 150 associated with the worker.

The worker registration engine 215 may further allow entities to provide feedback regarding workers who have completed microtasks 130. For example, an entity may use the microtask client 120 to provide a score or rating to the worker who completed a microtask 130, or may leave a comment regarding the worker. These comments and/or ratings may be viewed by other entities and may be used to select workers to complete microtasks 130. In addition, a worker may similarly provide feedback regarding an entity and/or a microtask 130 through the worker registration engine 215.

The worker information 150 associated with a worker may be stored by the worker registration engine 215 as worker data 212. In some implementations, the worker data 212 may include an entry for each worker along with metadata that includes worker information 150 entered and collected from each worker.

The selection engine 225 may select a microtask 130 to be completed. The selection engine 225 may select a microtask 130 for completion from the microtask data 211. Depending on the implementation, the selection engine 225 may select microtasks based on the priority information associated with each microtask. In addition, the selection engine 225 may select microtasks 130 based on the date that they were created or added to the microtask data 211.

In addition, the selection engine 225 may select one or more workers to complete a selected microtask 130. The selection engine 225 may select a worker to complete the microtask 130 based on the metadata associated with the microtask 130, the metadata associated with each worker in the worker data 212, and a selection model 217. The selection model 217 may consider the metadata associated with a microtask 130 (e.g., the type of the microtask, the desired skills and experience associated with the microtask, and any compensation associated with the microtask) as well as the metadata associated with the workers (e.g., the expertise and education associated with the workers, the ratings of the workers, and desired compensation) and may generate a list of workers that may be suitable to perform the microtask 130. The selection engine 225 may also consider the types of devices used by the workers and their suitability to particular microtasks 130 (e.g., smartphones may be more or less suitable for different microtasks 130 than a desktop computer). The selection engine 225 may assign the microtask 130 to some or all of the workers in the generated list of workers.

Because workers may refuse an assigned microtask 130, the microtask 130 may be assigned to multiple workers to ensure that the microtask 130 is completed. Once an assigned microtask 130 has been completed by a worker as indicated by received results 140, the assignments made to any other workers may expire or may be revoked by the selection engine 225. Where the workflow or metadata specifies that multiple workers may complete the same microtask 130 so that the entity may select from multiple results, the selection engine 225 may revoke any remaining assignments after the desired number of results 140 have been received.

The selection engine 225 may further consider the availability of workers when selecting workers to complete a selected microtask 130. As described above, a worker is considered to be in a working state when they are available to perform microtasks 130. Depending on the implementation, the selection engine 225 may determine if workers are in a working state based on a variety of factors such as the current date or time and the availability information provided by each of the workers and/or determined by the worker registration engine 215 in the worker data 212. For example, the availability information may indicate that a particular worker is available between 1 pm and 2 pm. If the current time is between 1 pm and 2 pm, then the selection engine 225 may determine that the worker is in a working state.

In some implementations, whether or not the worker is in a working state may depend on information that may be provided by the client device 110 and/or the microtask client 120. For example, as described above, some workers may specify that they desire to receive microtasks when they are closing a particular application 117 or are at a particular location. In such situations, the selection engine 225 may use sensor data and/or operating system data received from the client device 110 associated with the worker to determine if the worker is in a working state. The information may be provided periodically from the client device 110 and/or the microtask client 120 to the selection engine 225, or may be provided when request by the selection engine 225, for example.

Depending on the implementation, once a microtask 130 has been completed and results 140 have been received from the selected one or more workers, the selection engine 225 may mark the microtask 130 as completed and may remove the microtask 130 from the microtask data 211. In addition, the selection engine 225 may provide the results 140 to the associated entity. The entity may approve the results 140, or may request that the microtask 130 be redone.

In some implementations, the received results 140 may trigger the creation of additional microtasks 130 by the microtask creating engine 215 based on the received results and according to the workflow associated with the completed microtask 130. For example, if several shortened versions of a paragraph are received for an entity, the microtask creation engine 210 may create a microtask 130 for the entity that is to select the preferred version of the paragraph as indicated by the workflow. In general, the act of approving or accepting a particular result 140 may be considered a microtask 130 for the entity and may be selected by the selection engine 225 and completed by the entity as described above.

In addition, the entity may be asked to provide feedback or rating information regarding the completed microtask 130. Any feedback or rating information may be added to the worker data 212 associated with the worker by the microtask engine 160. Where applicable, the microtask engine 160 may further facilitate payment to the worker for the microtask 130 by the entity.

In some implementations, rather than ask a worker to complete a microtask 130, the microtask 130 may be automatically completed by the microtask engine 160. Depending on the implementation, the microtask engine 160 may complete the microtask 130 using natural language processing or machine learning. For example, where the microtask 130 is to shorten a paragraph, the microtask engine 160 may attempt to automatically shorten the paragraph. The automatically shortened paragraph may be presented to the user for approval as results 140 described above.

Depending on the implementation, when automatically completing microtasks 130, the microtask engine 160 may generate multiple results 140 and may present the multiple results 140 as options to the user or creator of the microtask 130. For example, where the microtask 130 is to shorten a paragraph, the microtask engine 160 may generate four different possible shortened paragraphs and the user may select the shortened paragraph that they prefer. The selected paragraph (and the not selected paragraphs) may be used as feedback to improve how the microtask engine 160 automatically performs the microtask 130 in the future.

In some implementations, the microtask engine 160 may learn how to automatically perform microtasks 130 by observing user behavior with respect to microtasks 130. For example, for a microtask 130 such as shortening a paragraph, the microtask engine 160 may determine that the user prefers paragraphs that have fewer than five sentences. The microtask engine 160 may then identify paragraphs having more than five sentences as possible candidates for shortening, or may automatically shorten the identified paragraph for the user.

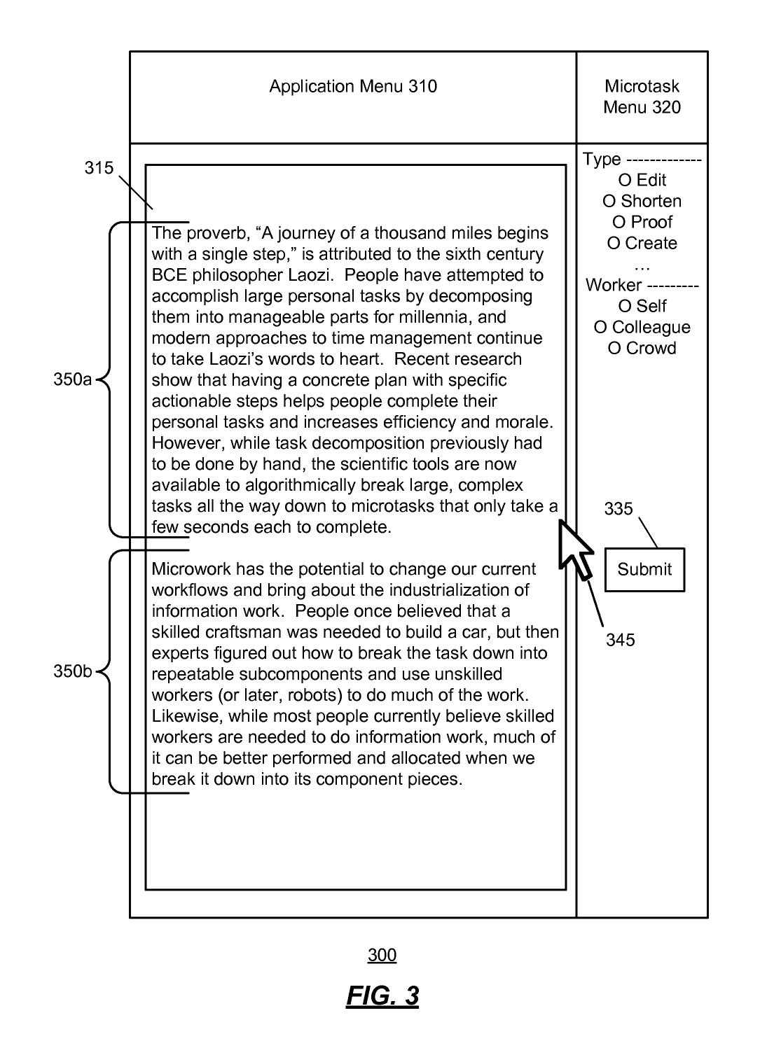

FIG. 3 is an illustration of an example user interface 300 for identifying and/or creating microtasks 130. The user interface 300 may be generated and presented to an entity at a client device 110 such as a desktop or laptop computer. The user interface 300 includes an application menu 310 and a content window 315. The application menu 310 and content the window 315 may be part of a content item creation application 117. In the example shown, the application 117 may be a document editing application such as a word processing application. The entity may enter and edit text for the content item 115 into the content window 315.

In order to incorporate microtasks 130 into the application 117, the user interface 300 may further include a microtask menu 320. The microtask menu 320 may allow entities to select workflows, create microtasks 130, and set various options related to the microtasks 130, from within the application 117 as they create the content item 115. Depending on the implementation, the microtask menu 320, and the functionality associated with the microtask menu 320, may be provided by the microtask client 120.

In the example shown, the entity has entered two paragraphs of text (i.e., the paragraphs 350a and 350b) into the content window 315. The entity may desire to shorten the text of the paragraph 350a and may use the pointer 345 to select the paragraph 350a in the content window 315. After selecting the paragraph 350a, the entity may select the type of microtask 130 to be performed using the contents of the paragraph 350a. Examples of types shown in the microtask menu 320 include “edit”, “shorten”, “proof”, and “create.” Other types of microtasks 130 may be supported.

In addition, the entity may specify the type of worker desired to complete the microtask 130. Examples of types shown in the microtask menu 320 include “self”, “colleague”, and “crowd.” The option “self” may correspond to selfsourcing and may specify that the microtask 130 be completed by the entity that is creating the microtask 130. The options “colleague” and “crowd” may correspond to crowdsourcing. The option “colleague” may limit the workers that may complete the microtask 130 to workers that are colleagues or that otherwise know the entity. The option “crowd” may specify that any qualified worker may work on the microtask 130. While not shown, other options may be included in the microtask menu 320 for selection and/or specification such as skills or education desired for the workers, a desired completion date for a microtask 130, a compensation associated with the microtask 130, and a number of workers that the entity desires to work on the microtask 130.

Using the pointer 345, the entity may select the options associated with the microtask 130 type “edit” and the worker “self”, and may create a microtask 130 by actuating the button 335 labeled “submit.” In response, the generated microtask 130 corresponding to the paragraph 350a and associated metadata may be provided by the microtask client 120 to the microtask engine 160 where the microtask 130 may be added to the microtask data 211 for later completion. In addition, the entity may similarly create a microtask corresponding to the paragraph 350b.

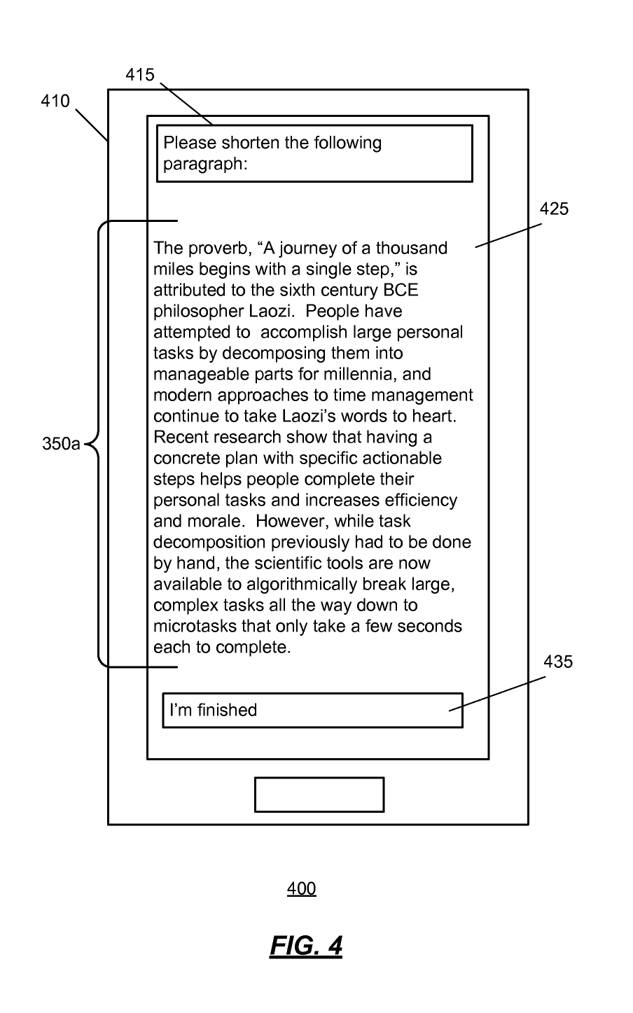

FIG. 4 is an illustration of an example user interface 400 through which an entity may complete an assigned microtask 130. The user interface 400 may be implemented by a smart phone 410, although other types of client devices 110 may be used. The user interface 400 includes a content window 425 in which the microtask 130 is displayed to the entity, along with an instructions window 415 where instructions on how to complete the microtask 130 are displayed.

Continuing the above example, the microtask 130 corresponding to the paragraph 350a is displayed to the entity in the content window 425. The selection engine 225 and/or the microtask client 120 on the smart phone 410 may have determined that the entity was in a working state and therefore may be available to complete a microtask 130. For example, using the GPS associated with the smart phone 410, the microtask client 120 may have determined that the entity is waiting in line at a store and may have requested a microtask 130 for the entity to complete, or the entity may have affirmatively requested a microtask 130. Because the microtask 130 is of the type “shorten”, the instructions window 415 instructs the entity to “Please shorten the following paragraph.”

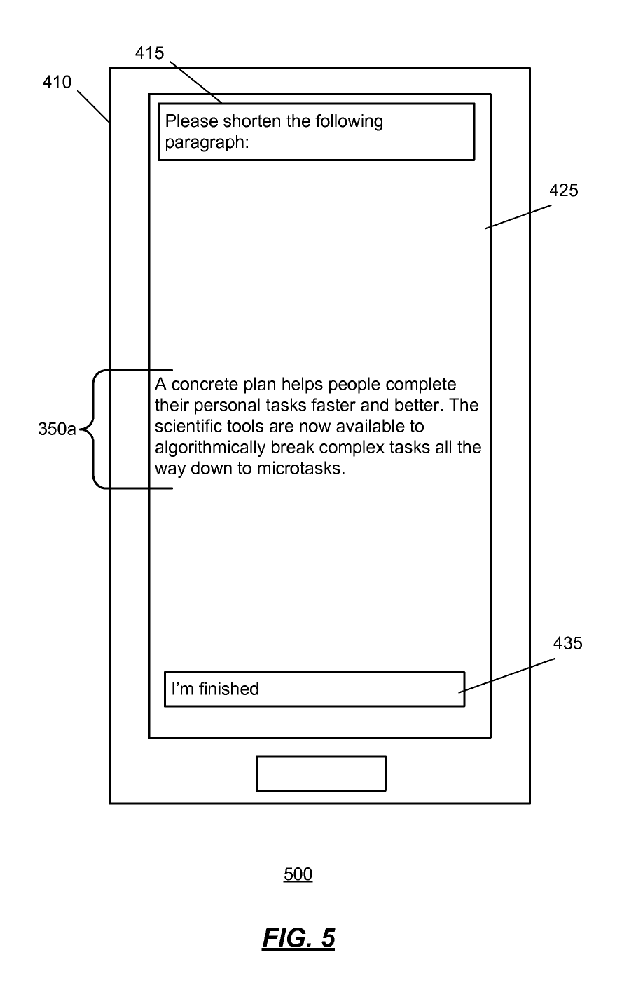

Continuing to the user interface 500 of FIG. 5, the entity has completed the microtask 130 and has shortened the paragraph 350a in the content window 425. After completing the microtask 130, the entity may submit the shortened paragraph as the results 140 by actuating the button 435 labeled “I'm finished.” In response, the microtask client 120 may provide the results 140 to the microtask engine 160. Alternatively or additionally, the microtask client 120 may incorporate the results 140 into the content item 115 associated with the microtask 130.

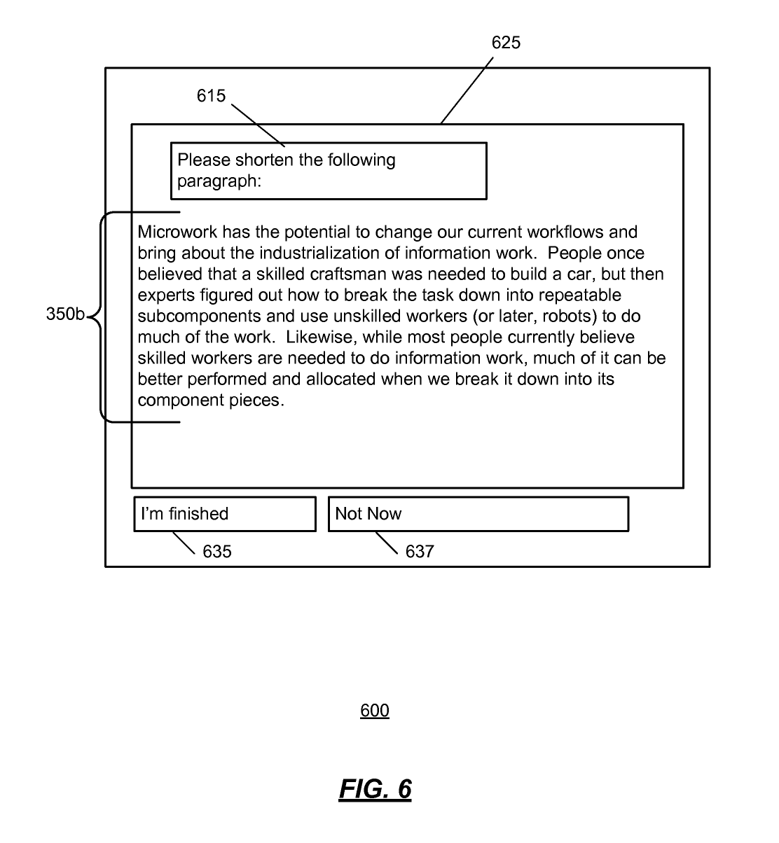

FIG. 6 is an illustration of an example user interface 600 that may be used to complete the microtask 130 corresponding to the paragraph 350b. The user interface 600 may be a window or other user interface element that may be displayed to the entity on a client device 110 such as a desktop or a laptop computer. Similar to the user interface 400, the user interface 600 includes a content window 625 in which the microtask 130 is displayed to the entity, along with an instructions window 615 where instructions on how to complete the microtask 130 are displayed.

The microtask client 120 on the client device 110 may have determined that the entity was in a working state and therefore may be available to complete a microtask 130. For example, the microtask client 120 may detect that the entity has just closed an application 117 or file which may indicate that the entity is available to complete a microtask 130. Because the microtask is of the type “shorten”, the instructions window 615 instructs the entity to “Please shorten the following paragraph.”

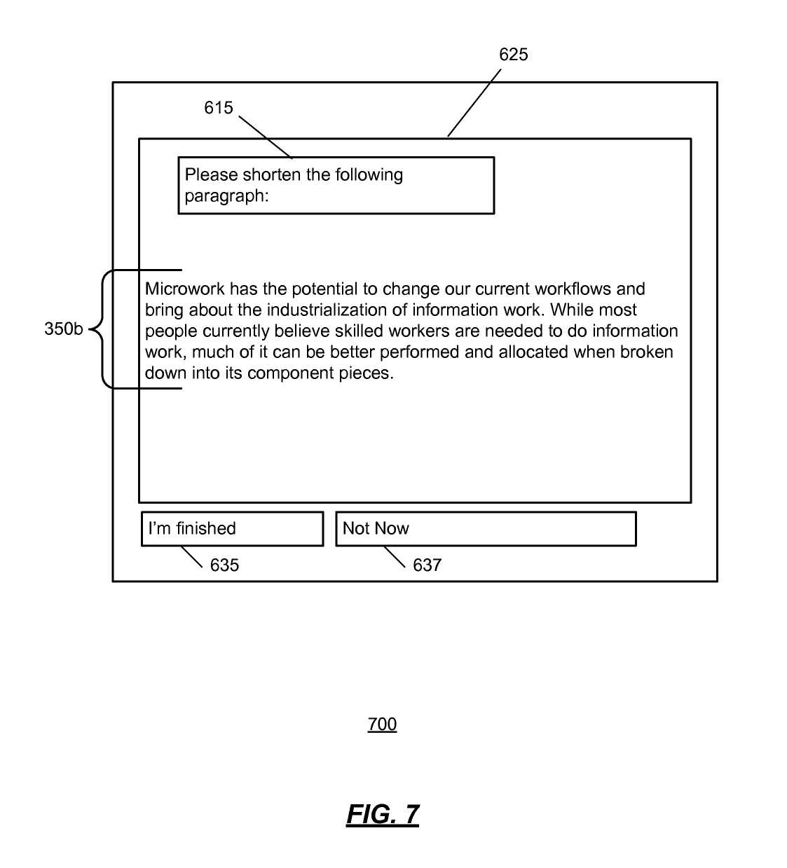

Continuing to the user interface 700 of FIG. 7, the entity has completed the microtask 130 and has shortened the paragraph 350b. After completing the microtask 130, the entity may submit the shortened paragraph as the results 140 by actuating the button 635 labeled “I'm finished.” In addition, should the entity not desire to complete the microtask 130 at this time, the entity may actuate a button 637 labeled “not now.” The entity may then be presented with the microtask 130 at some later time.

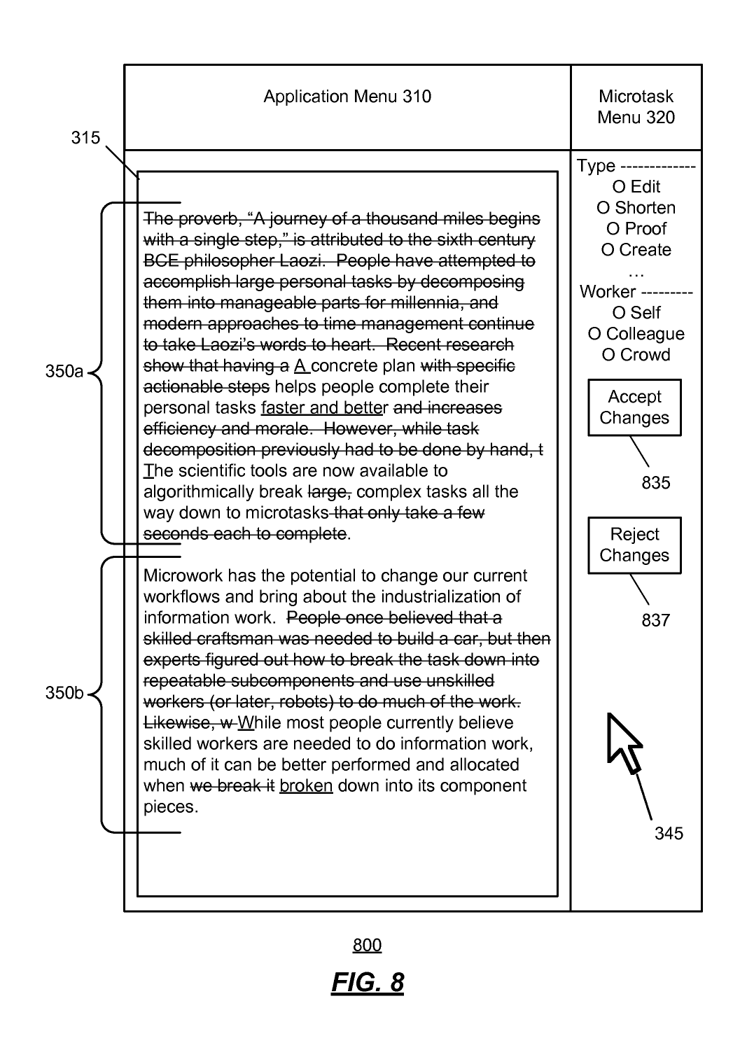

FIG. 8 is an illustration of a user interface 800 after the microtasks corresponding to the paragraphs 350a and 350b have been completed. In the example shown, the paragraphs 350a and 350b are displayed in the content window 315 to show the changes that were made to each of the paragraphs due to the “shorten” microtasks 130 shown in FIGS. 5 and 7. The user interface 800 includes a button 835 labeled “Accept Changes” and a button 837 labeled “Reject Changes” that the entity may use to either accept or reject the edits proposed by the completed microtasks 130. In some implementations, users may be provided with the option to accept or reject specific portions of the completed microtasks 130.

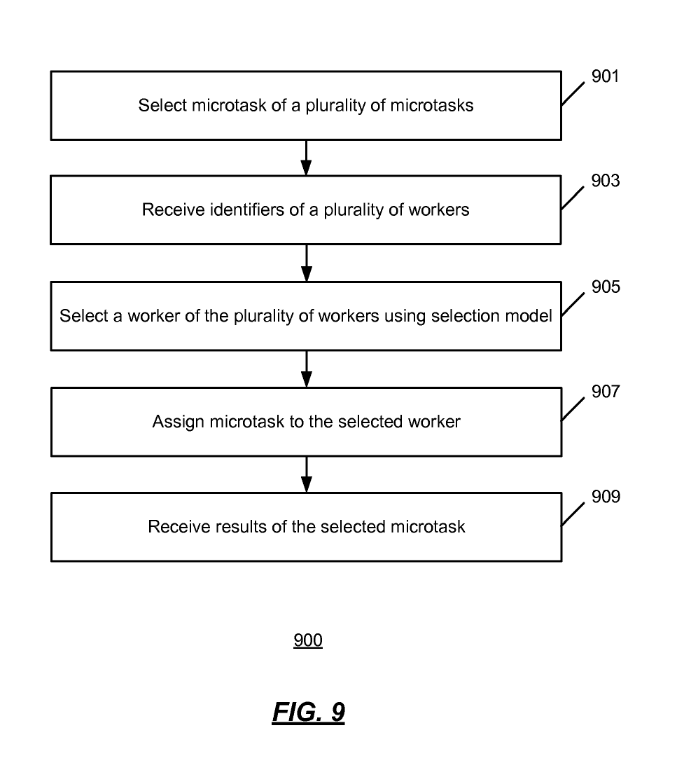

FIG. 9 is an operational flow of an implementation of a method 900 for selecting a microtask 130 and for receiving results 140 of the selected microtask 130. The method 900 may be implemented by the microtask engine 160.

At 901, a microtask of a plurality of microtasks is selected. The microtask 130 may be selected by the selection engine 225 of the microtask engine 160 from a plurality of microtasks 130 stored in the microtask data 211. The microtask 130 may be randomly selected by the selection engine 225, or may be a stored microtask 130 having a highest priority. Alternatively or additionally, the microtask 130 may be selected by the selection engine 225 using a selection model 217.

Depending on the implementation, the selected microtask 130 may be associated with metadata that includes an entity and a type. The entity may be the entity that is responsible for the content item 115 associated with the selected microtask 130. The type may identify the task that is associated with the selected microtask 130 such as editing, re-writing, shortening the content, summarizing, reviewing, proofreading, etc. Other types of microtasks may be identified. In addition, the type may be associated with a workflow. The workflow may include the steps that may be completed as part of the selected microtask 130. The workflow may also include parameters that define any compensation that may be associated with the microtask 130, the number and skill sets of any workers that may be used to complete the microtask 130, and whether or not the microtask 130 may be assigned to multiple workers simultaneously.

At 903, identifiers of a plurality of workers are received. The identifiers of the plurality of workers may be received by the worker registration engine 215. Each worker may have associated metadata such as availability information and/or expertise information. In some implementations, each identified worker may have signed up or registered to perform one or more microtasks 130.

At 905, a worker of the plurality of workers is selected. The worker may be selected by the selection engine 225 of the microtask engine 160 using a selection model 217. The selected worker may be the worker that is best suited for the microtask 130 and/or the most available or willing to perform the microtask 130. Depending on the implementation, the selection engine 225 and selection model 217 may consider a variety of factors when selecting the worker such as the expertise of the worker, the type of the microtask 130, compensation associated with the microtask 130 and/or the worker, a rating associated with the worker, the availability of the worker, a current location of the worker, a current time, a schedule associated with the worker, and a current state associated with the worker. The state associated with a worker may indicate if the worker is busy, has just started or finished a task, is waiting in line, is taking public transportation, etc. The state of the worker may be determined by one or more sensors (e.g., GPS, accelerometer, proximity sensor, thermometer, etc.) or operating system data associated with the client device 110 of the worker, for example.

At 907, the selected microtask is assigned to the worker. The selected microtask 130 may be assigned to the worker by the selection engine 225 of the microtask engine 160. Depending on the implementation, the selection engine 225 may assign the microtask 130 to the worker by sending the worker a message, such as an email, to an address associated with the worker. The worker may then choose to accept or reject the assigned microtask 130 using the client device 110 associated with the worker. Alternatively, the selection engine 225 may assign the microtask 130 by sending the assigned microtask 130 to the microtask client 120 on the client device 110 of the worker. The microtask client 120 may then determine when to present the microtask 130 to the selected worker.

At 909, results of the selected microtask are received. The results 140 may be received by the microtask engine 160 from the selected worker. Depending on the implementation, the microtask engine 160 may store the results 140 with the microtask data 211 and may provide the results 140 to the entity that created or initiated the microtask 130. The results 140 may be provided directly to the entity, or may be provided to the microtask client 120 associated with the entity.

Depending on the implementation, the microtask engine 160 may deem the microtask 130 completed after the entity approves of the results 140, or some amount of time has passed since the results 140 were provided. Where reviews or other indicators of quality are received from the entity regarding the results 140 and/or the performance of the selected worker, the information may be added to the metadata associated with the worker in the worker data 212. If there is compensation associated with the microtask 130, the microtask engine 160 may credit the worker and debit the entity according to the associated compensation.

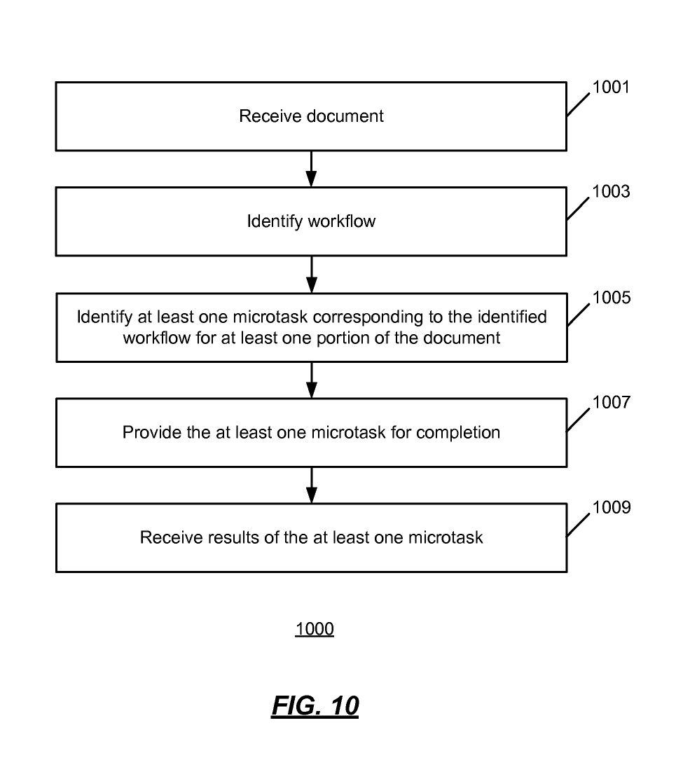

FIG. 10 is an operational flow of an implementation of a method 1000 for identifying at least one microtask 130 in a document and for receiving results 140 of the at least one microtask 130. The method 1000 may be implemented by the microtask engine 160 and/or the microtask client 120.

At 1001, a document is received. The document may be received by one or more of a microtask client 120 or a microtask engine 160. The document may be a text document and may include a plurality of text portions. For example, the document may be a webpage or a word processing document.

At 1003, a workflow is identified. The workflow may be identified by the entity associated with the document of the microtask engine 160. Each workflow may be associated with one or more microtasks 130 such as editing or proofreading a document. Each workflow may further identify requirements or other parameters for the microtasks 130. For example, the workflow may identify the number of workers that may complete the microtask 130, any additional information or content that may be provided to the workers to help them complete the microtask 130, and the qualifications desired for the workers that complete the microtask 130.

At 1005, at least one microtask corresponding to the identified workflow for at least one portion of the document is identified. The microtask 130 may be identified by the microtask client 120 or the microtask creation engine 210 of the microtask engine 160. In some implementations, the microtasks 130 may be automatically identified in the document by text matching patterns against patterns associated with known microtasks 130 corresponding to the identified workflow. For example, the microtask creation engine 210 or microtask client 120 may identify paragraphs with spelling or grammatical errors as microtasks 130 of the type “edit” or “rewrite.” Alternatively, the microtask 130 may be identified by the entity associated with the client device 110 using a user interface or other means of selection. For example, the entity may highlight a paragraph and may select the microtask 130 type “shorten.” Other techniques for identifying microtasks 130 may be used.

At 1007, the at least one microtask is provided for completion. The at least one microtask 130 may be provided by the microtask client 120 to a selected worker at a client device associated with the selected worker. The worker may complete the at least one microtask 130.

At 1009, results of the at least one microtask are received. The results 140 may be received by the microtask engine 160 from the microtask client 120 of the client device 110 associated with the selected worker. Depending on the implementation, the results 140 may be incorporated into the document at the at least one portion of the document. Alternatively, the results 140 may be presented to the entity.

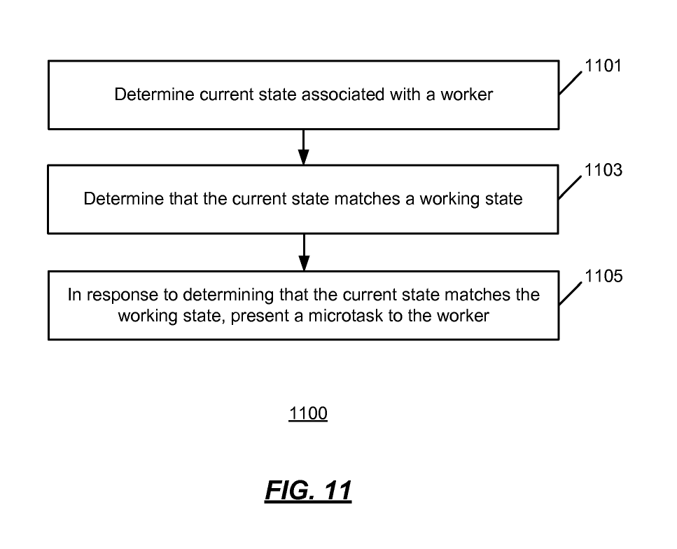

FIG. 11 is an operational flow of an implementation of a method 1100 for determining that a current state associated with a worker matches a working state and in response to the determination, presenting a microtask 130 to the worker. The method 1100 may be implemented by the microtask engine 160.

At 1101, a current state associated with a worker is determined. The current state of the worker may be determined by the selection engine 225 of the microtask engine 160 or the microtask client 120. Depending on the implementation, the worker may be also be the entity that is associated with the particular content item 115 associated with a microtask 130.

The current state of a worker or entity may be a collection of information about the worker and may include information such as a location of the worker, the current time or date, which applications 117 that the worker is current using, whether or not the worker has just opened or closed an application 117 or file, whether or not the worker has just logged into their client device 110, a schedule or calendar associated with the worker, and whether or not the worker has identified themselves as available or has requested a microtask 130. Other types of information may be included in the state of the worker.

At 1103, it is determined that the current state matches a working state. The determination may be made by the selection engine 225 of the microtask engine 160 or the microtask client 120 using the selection model 217. The selection model 217 may determine whether the current state of the worker or entity is a working state (i.e., a state that the worker or entity may be available to complete a microtask 130).

For example, the selection model 217 may indicate the current state of the worker is a working state if the information associated with the current state indicates that the worker is in a location associated with the worker being available to complete a microtask 130 (e.g., in line, at home, on public transportation, etc.), or has just completed another project or task and may be receptive to completing a microtask 130 (e.g., the user has just closed an application 117, or saved a file).

At 1105, in response to determining that the current state matches a working state, a microtask is presented to the worker. The microtask 130 may be presented to the worker on the client device 110 associated with the worker. Depending on the implementation, the microtask 130 may be presented by the microtask client 120 using a graphical user interface such as the user interface 400. Alternatively or additionally, the microtask 130 may be presented to the worker by sending a message (e.g., text, email, or other means) to the worker that includes a link or other reference to the microtask 130.

FIG. 12 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 12, an exemplary system for implementing aspects described herein includes a computing device, such as computing device 1200. In its most basic configuration, computing device 1200 typically includes at least one processing unit 1202 and memory 1204. Depending on the exact configuration and type of computing device, memory 1204 may be volatile (such as random access memory (RAM)), non-volatile (such as read-only memory (ROM), flash memory, etc.), or some combination of the two. This most basic configuration is illustrated in FIG. 12 by dashed line 1206.

Computing device 1200 may have additional features/functionality. For example, computing device 1200 may include additional storage (removable and/or non-removable) including, but not limited to, magnetic or optical disks or tape. Such additional storage is illustrated in FIG. 12 by removable storage 1208 and non-removable storage 1210.

Computing device 1200 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1204, removable storage 1208, and non-removable storage 1210 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 1200.

Computing device 1200 may contain communication connection(s) 1212 that allow the device to communicate with other devices. Computing device 1200 may also have input device(s) 1214 such as a keyboard, mouse, pen, voice input device, touch input device, etc. Output device(s) 1216 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a microtask of a plurality of microtasks is selected by a computing device, wherein each microtask is associated with metadata comprising an entity and a type. Identifiers of a plurality of workers are received by the computing device, wherein each worker is associated with metadata comprising an expertise. A worker of the plurality of workers is selected using a selection model, the metadata associated with each microtask, and the metadata associated with each worker by the computing device. The selected microtask is assigned to the selected worker by the computing device. A result of the selected microtask is received from the selected worker by the computing device.

Implementations may include some or all of the following features. The selected microtask may be associated with a content item and the selected microtask may comprise one or more of editing the content item, re-writing the content item, shortening the content item, summarizing the content item, reviewing the content item, or proofreading the content item. The metadata associated with each microtask may further comprise a workflow. The received result may be presented to the entity associated with the selected microtask. That the selected worker is available may be determined based on one or more of a current time, a location of the selected worker, and a schedule associated with the selected worker, and in response to determining that the selected worker is available, the selected microtask may be presented to the selected worker. Presenting the selected microtask to the selected worker may comprise presenting the selected microtask to the worker on a mobile computing device associated with the selected worker. A current state associated with the selected worker may be determined, that the current state matches a working state may be determined, and in response to determining that the current state matches a working state, the selected task may be presented to the selected worker. The current state may comprise one or more of opening an application, closing an application, turning on a device, turning off a device, unlocking the device, charging the device, saving a document, opening a document, closing a document, waiting for a message, and waiting for an application. An indication that the selected worker is available to perform a microtask may be received, and in response to the indication, that the current state matches the working state may be determined.

In an implementation, a document comprising a plurality of text portions is received by a computing device, wherein the document is associated with an entity. A workflow is identified. At least one microtask corresponding to the identified workflow for at least one text portion of the plurality of text portions is identified by the computing device, wherein the at least one microtask is associated with metadata comprising a type. The at least one microtask is provided for completion based on the identified workflow by the computing device.

Implementations may include some or all of the following features. Identifying the at least one microtask may comprise receiving a user selection of the at least one text portion for the identified at least one microtask. Identifying the at least one microtask may comprise matching a pattern associated with the at least one microtask with the at least one text portion. Providing the at least one microtask for completion based on the identified workflow may comprises receiving identifiers of a plurality of workers, wherein each worker is associated with metadata comprising an expertise and availability information, selecting a subset of workers of the plurality of workers using a selection model, the metadata associated with the at least one microtask, the metadata associated with each worker, and the identified workflow, assigning the at least one microtask to the selected subset of workers, and receiving a result of the at least one microtask from each worker of the subset of workers. Two or more of the received results of at least one microtask may be presented, and a selection of one of the presented two or more of the received results may be received. At least one of the received results may be presented along with the received document to the entity. Presenting at least one of the received results along with the received document to the entity may include displaying the at least one of the received results along with the received document, wherein the at least one of the received results is displayed as an edit to the at least one text portion associated with the at least one microtask. Providing the at least one microtask for completion based on the identified workflow may include automatically completing the at least one microtask by the computing device.

In an implementation, a system may include at least one computing device and a microtask engine. The microtask engine may be adapted to receive a plurality of microtasks for a content item associated with an entity, determine a state associated with the entity, determine that the determined state is a working state for the entity, in response to determining that the determined state is a working state, select a microtask of the plurality of microtasks, and provide the selected microtask for completion by the entity at the at least one computing device.

Implementations may include some or all of the following features. The content item may comprise a document and the selected microtask may comprise one or more of editing the content item, re-writing the content item, shortening the content item, summarizing the content item, reviewing the content item, or proofreading the content item. The state associated with the entity may comprise one or more of opening an application, closing an application, turning on the at least one computing device, turning off the at least one computing device, unlocking the at least one computing device, charging the at least one computing device, saving a document, opening a document, and closing a document. The microtask engine may be further adapted to receive one or more of sensor data or operating system data from the at least one computing device, and determine the state associated with the entity based on the received one or more of sensor data or operating system data.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
selecting a microtask of a plurality of microtasks by a computing device, wherein each microtask is associated with metadata comprising an entity and a type;
receiving identifiers of a plurality of workers by the computing device, wherein each worker is associated with metadata comprising an expertise;
selecting a worker of the plurality of workers using a selection model, the metadata associated with each microtask, and the metadata associated with each worker by the computing device;
assigning the selected microtask to the selected worker by the computing device; and
receiving a result of the selected microtask from the selected worker by the computing device.

2. The method of claim 1, wherein the selected microtask is associated with a content item and the selected microtask comprises one or more of editing the content item, re-writing the content item, shortening the content item, summarizing the content item, reviewing the content item, or proofreading the content item.

3. The method of claim 1, wherein the metadata associated with each microtask further comprises a workflow.

4. The method of claim 1, further comprising presenting the received result to the entity associated with the selected microtask.

5. The method of claim 1, further comprising:
determining that the selected worker is available based on one or more of a current time, a location of the selected worker, and a schedule associated with the selected worker; and
in response to determining that the selected worker is available, presenting the selected microtask to the selected worker.

6. The method of claim 5, wherein presenting the selected microtask to the selected worker comprises presenting the selected microtask to the worker on a mobile computing device associated with the selected worker.

7. The method of claim 1, further comprising:
determining a current state associated with the selected worker;
determining that the current state matches a working state; and
in response to determining that the current state matches a working state, presenting the selected task to the selected worker.

8. The method of claim 7, wherein the current state comprises one or more of opening an application, closing an application, turning on a device, turning off a device, unlocking the device, charging the device, saving a document, opening a document, closing a document, waiting for a message, and waiting for an application.

9. The method of claim 7, further comprising receiving an indication that the selected worker is available to perform a microtask, and in response to the indication, determining that the current state matches the working state.

10. A method comprising:
receiving a document comprising a plurality of text portions by a computing device, wherein the document is associated with an entity;
identifying a workflow for the document by the computing device;
identifying at least one microtask for at least one text portion of the plurality of text portions corresponding to the identified workflow by the computing device, wherein the at least one microtask is associated with metadata; and
providing the at least one microtask for completion based on the identified workflow by the computing device.

11. The method of claim 10, wherein identifying the at least one microtask comprises matching a pattern associated with the at least one microtask and the workflow with the at least one text portion.

12. The method of claim 10, wherein providing the at least one microtask for completion based on the identified workflow comprises:
receiving identifiers of a plurality of workers, wherein each worker is associated with metadata comprising an expertise and availability information;
selecting a subset of workers of the plurality of workers using a selection model, the metadata associated with the at least one microtask, the metadata associated with each worker, and the identified workflow;
assigning the at least one microtask to the selected subset of workers; and
receiving a result of the at least one microtask from each worker of the subset of workers.

13. The method of claim 12, further comprising presenting two or more of the received results of the at least one microtask, and receiving a selection of one of the presented two or more of the received results.

14. The method of claim 12, further comprising:
presenting at least one of the received results along with the received document to the entity.

15. The method of claim 14, wherein presenting at least one of the received results along with the received document to the entity comprises displaying the at least one of the received results along with the received document, wherein the at least one of the received results is displayed as an edit to the at least one text portion associated with the at least one microtask.

16. The method of claim 10, wherein providing the at least one microtask for completion based on the identified workflow comprises automatically completing the at least one microtask by the computing device.

17. A system comprising:
at least one computing device; and
a microtask engine adapted to:
receive a plurality of microtasks for a content item associated with an entity;
determine a state associated with the entity;
determine that the determined state is a working state for the entity;
in response to determining that the determined state is a working state, select a microtask of the plurality of microtasks; and
provide the selected microtask for completion by the entity at the at least one computing device.

18. The system of claim 17, wherein the content item comprises a document and the selected microtask comprises one or more of editing the content item, re-writing the content item, shortening the content item, summarizing the content item, reviewing the content item, or proofreading the content item.

19. The system of claim 17, wherein the state associated with the entity comprises one or more of opening an application, closing an application, turning on the at least one computing device, turning off the at least one computing device, unlocking the at least one computing device, charging the at least one computing device, saving a document, opening a document, and closing a document.

20. The system of claim 17, where the microtask engine is further adapted to:
receive one or more of sensor data or operating system data from the at least one computing device; and
determine the state associated with the entity based on the received one or more of sensor data or operating system data.
